(19) United States
(12) Patent Application Publication
(10) Pub. No.: US 2010/0187160 A1
(43) Pub. Date: Jul. 29, 2010

(54) METHOD FOR PURIFYING MINERAL OIL FRACTIONS AND DEVICE SUITABLE FOR CONDUCTING SAID METHOD

(75) Inventors: Jochen Latz, Koeln (DE); Ralf Peters, Wuerselen (DE); Detlef Stolten, Aachen (DE)

Correspondence Address: JORDAN AND HAMBURG LLP, 122 EAST 42ND STREET, SUITE 4000, NEW YORK, NY, 10168, US

(73) Assignee: Forschungszentrum Juelich GmbH, Juelich (DE)

(21) Appl. No.: 12/733,688

(22) PCT Filed: Sep. 11, 2008
(86) PCT No.: PCT/DE2008/001531

§ 371 Date: Mar. 15, 2010

(30) Foreign Application Priority Data
Sep. 27, 2007 (DE) 10 2007 046 126.9

(51) Int. Cl. C10G 45/02; B01J 8/02

(52) U.S. Cl. 208/213; 422/139; 422/218; 196/46

(57) ABSTRACT

Disclosed is a method for reducing the organic sulfur content in a sulfur-containing liquid fuel, wherein the sulfur-containing fuel is first brought in contact with a hydrogen-containing gas in a presaturator and subsequently the hydrogen-enriched liquid fuel is brought in contact with a suitable adsorbent in a reactor. The adsorbent is able to adsorb at least part of the sulfur and/or of the sulfur compound from the fuel at the surface. The contact with the adsorbent can advantageously take place not only at higher temperatures of approximately 400° C., but also at moderate temperatures, as low as room temperature, because the use of liquid fuel ensures very good contact between the fuel and the surface of the adsorbent, and therefore ensures reduction of the sulfur content.

### BACKGROUND OF THE INVENTION

The invention relates to a method for purifying mineral oil fractions, and particularly for desulfurizing such fractions. The invention furthermore relates to a device suited to carrying out the method.

Sulfur is a common constituent of natural mineral oils. When used as fuel, however, sulfur in the mineral oil has several disadvantages. For example, sulfur typically corrodes engine components when burned in an engine. The combustion of gasoline produces sulfur dioxide, among other things, which substantially contributes to the formation of smog and acid rain. Furthermore, modern engines and downstream exhaust gas purification systems would be lastingly damaged by high sulfur contents. When used in fuel cell systems, sulfur compounds in the reformer and in the fuel cell usually result in a loss of catalytic activity.

Today, substantially sulfur-free diesel fuel is used, which reduces soot formation, and in particular the formation of small soot particles, which can only be filtered out using a particulate filter.

The “extensive” supply of sulfur-free gasoline and diesel fuel, which is to say containing a maximum of 10 mg sulfur per kg of fuel, has been mandated for Germany and Europe by 2009. Effective Jan. 1, 2008, heating oil may contain no more than 1000 ppm of sulfur, and Jet A1 kerosene no more than 3000 ppm of sulfur. In practical terms, however, kerosene in the EU already contains less than 800 ppm of sulfur. As of 2009, the supply of “sulfur-free” gasoline and diesel is to be “comprehensive”.

The removal of sulfur and sulfur compounds from mineral oil products is referred to as desulfurization. Since natural mineral oil fractions have sulfur contents of up to several percent, mineral oil products generally first have to be desulfurized in order to comply with regulatory levels.

The desulfurization method of liquid fuels employed almost exclusively in refinery technology is hydrodesulfurization in the gas phase, or a trickle bed reactor (HDS—hydrodesulfurization). For light mineral oil fractions, the gaseous fuel is conducted through the reactor together with the hydrogen required for the reaction. Hydrogen can be added either as a pure gas or as part of a gas mixture. For heavy mineral oil fractions, the liquid fuel is conducted through a three-phase trickle bed reactor together with gaseous hydrogen. In the reactor, a solid catalyst, liquid fuel, and gaseous hydrogen are present. The hydrocarbons containing sulfur are converted into hydrogen sulfide. Downstream of the reactor, the excess hydrogen-containing gas is treated further, for example, in that it is separated, condensed, and subsequently returned to the process. Separating the hydrogen sulfide from the product flow can be achieved, for example, by adsorption or multi-stage amine gas treatment. The separated hydrogen sulfide can then be transformed into elemental sulfur by way of a catalytic reaction using atmospheric oxygen in a Claus plant.

The disadvantage of hydrogenation in the gas phase or the trickle bed reactor is that a very large excess amount of hydrogen is required in the reactor due to poor phase transitions. The excess hydrogen must be separated again downstream of the reactor, condensed, and fed back into the reactor. The disadvantage associated with this, however, is a significant energy expenditure and apparatus-related cost. If a hydrogen-containing gas mixture is to be used instead of pure hydrogen for hydrogenation, the hydrogen content in the reactor is reduced due to the required circulation. As a result, operations are not economical when using a hydrogen-containing gas mixture.

In addition, the HDS method reaches its limits in removal of the organically bound sulfur in order to comply with the more stringent regulatory level of 10 ppm, and this can only be ensured by way of increased energy and resource utilization. Further tightening of the regulatory levels for mineral oil products is to be expected in the future. Alternative concepts for obtaining sulfur-free fuels, which constitute more cost-effective processes than the HDS method in terms of energy expenditure and equipment, are therefore of tremendous ecological and economical interest.

A new approach is the presaturator equipped hydrofiner, which is known from WO 03/091363. According to the concept, a quantity of hydrogen sufficient for the hydrogenation reaction is dissolved in the fuel at high pressure and high temperature, so that an exclusively liquid phase passes through the reactor. According to the concept of hydrodesulfurization using a presaturator, only a liquid fuel phase and a solid catalyst phase are present in the reactor. Compared to the trickle bed reactor, this results in better mass transfer, whereby recycling of hydrogen can be eliminated. Subsequently, the gaseous hydrogen sulfide must also be separated from the product flow.

The disadvantage of the presaturator equipped hydrofiner is the limited solubility of hydrogen in the liquid fuel. If a hydrogen-containing gas is used, the hydrogen partial pressure is crucial. High overall pressure levels result if the proportions of other gases are significant. If the hydrogen solute is not sufficient for desulfurization, the fuel must be circulated, however this is less expensive and energy-intensive than the circulation of hydrogen.

A further new method is adsorptive desulfurization. Here, the fuel is brought in contact with an adsorbent. Depending on whether this is a simple or reactive adsorption step, the sulfur compounds, or sulfur liberated therefrom, is deposited on the surface of the adsorbent. After saturation, the adsorbent is usually regenerated. In order to allow for multiple regenerations of the adsorbent without encountering degradation effects, a hydrogen flow can be added during adsorption. This counteracts the formation of carbon deposits on the adsorber surface.

One example of such a process is the S Zorb process developed by ConocoPhillips, which is now employed in several refineries on an industrial scale. In this process, the sulfur-containing vaporized fuel and hydrogen are conducted over a special adsorbent in a fluidized bed reactor. In the process, sulfur is liberated from the organic sulfur compounds (reactive adsorption) and deposited on the surface of an adsorbent. While hydrogen consumption during this process is significantly lower than in the case of hydrodesulfurization, it is still necessary to add excess hydrogen during adsorption, which subsequently requires recycling. In terms of using a hydrogen-containing gas mixture, the same advantages apply as with conventional hydrodesulfurization.

During the S Zorb process, the adsorbent is continuously removed from the desulfurization process and regenerated, and can then be used again for adsorption. The S Zorb process employs oxidative regeneration with subsequent activation of the adsorbent, whereby sulfur is released during regeneration as sulfur dioxide. The additional step for separating hydrogen sulfide from the product flow can therefore be eliminated in this process.

The disadvantage of the method is that a high-volume exhaust gas flow having only low concentrations of SO₂ is produced, which requires separate, and therefore cost-intensive, treatment in the refinery operation. Additionally, while this process does not produce hydrogen sulfide, which inhibits further desulfurization, it requires hydrogen pressures of 7 to 35 bar for operation. As a result, the disadvantage is that likewise large amounts of hydrogen must be provided or circulated.

### SUMMARY OF THE INVENTION

It is an object of the invention to create a method for desulfurization, which at least partially overcomes these advantages of the prior art and which is also economical to operate. It is a further object of the invention to provide a suitable device for carrying out this method.

The objects of the invention are achieved by a method having all the characteristics of the main claim and by a device for carrying out the method according to the additional independent claim. Advantageous embodiments of the method and the device will be apparent from the dependent claims.

Within the context of the invention, it was found that the method of adsorptive desulfurization can be considerably improved, if the fuel that is supplied is first saturated with hydrogen in a presaturator, and the adsorption step is furthermore carried out at moderate temperatures.

Fuel here shall be understood as a fluid which can be obtained directly or indirectly by way of feedstock distillation. Such fuel usually comprises saturated hydrocarbons, for example straight-chain or branched alkanes or alicyclic hydrocarbons, referred to as naphthenes, and various quantities of aromatic compounds and/or unsaturated hydrocarbon compounds.

The method presented here is particularly suited to the desulfurization of gasoline and middle distillates having boiling temperatures between 150 and 450° C. Middle distillates refers to a fraction in refining from which the intermediate products of light fuel oil, diesel fuel, and kerosene are produced.

The primary constituents of diesel fuel include alkanes, cycloalkanes (naphthenes) and aromatic hydrocarbons having approximately 10 to 22 carbon atoms per molecule and a boiling range of 170° C. to 390° C. Gas oil (also straight-run middle distillate) is a light oil starting product for diesel fuel, which results directly from crude oil fractioning. The cetane number ranges from approximately 40 to 60 and is therefore very high. Often, the proportion of paraffins is high and the proportion of aromatic compounds is low. After desulfurization, it can be used for operating sophisticated diesel engines. Gasoline is a complex mixture of more than 100 different, predominantly light hydrocarbons, having a boiling range between that of gaseous hydrocarbons and petroleum/kerosene. It is obtained primarily through the refining and subsequent treatment of crude oil and is used as fuel for internal combustion engines (particularly spark-ignition engines). There are different types of gasolines, which differ in the manner of the composition of the hydrocarbons. Kerosene has a boiling range of approximately 180 to 230° C. Worldwide, kerosene is used, predominantly according to the Jet A1 specification, as jet fuel (USA: Jet-A). Petroleum has physical properties similar to those of diesel, but is a crude oil fraction that has a very narrow boiling range between that of gasoline and diesel.

The organic sulfur compounds occurring in these fuels or mineral oil fractions notably come from the group consisting of thioalcohols, sulfides, thiophene, benzothiophene and dibenzothiophene (DBT), and in particular also sterically hindered, alkyl-substituted dibenzothiophenes.

The proportions in which the above sulfur-containing compounds are present in the fuels as pure, elemental sulfur, expressed as a total proportion, generally range between 1,000-50,000 ppm S, and particularly between 5,000 and 20,000 ppm S. However, there are also crude oils, the individual products of which are considerably less than 1000 ppm, and sometimes even 10 ppm sulfur. Depending on the fractions, diesel in particular has high levels of dibenzothiophenes (approximately 100-20,000 ppm S) and sterically hindered dibenzothiophenes (approximately 50-5,000 ppm S), while gasoline tends more toward large amounts of thiophenes, and kerosene toward large amounts of benzothiophenes.

In the desulfurization process according to the invention, in a first step the fuel is brought in contact with a hydrogen-containing gas, such as water vapor or pure hydrogen, in a presaturator so that an amount of hydrogen sufficient for the adsorption step is dissolved in the fuel. The exact amount of hydrogen solute depends, among other things, on the pressure in the presaturator. The method according to the invention therefore allows the liquid fuel to be saturated with hydrogen, without further energy input, and thereby advantageously improves the mass transfer between the fuel, the hydrogen solute and the surface of the adsorbent.

The fuel is only saturated to the extent that hydrogen is required during the reaction. Full saturation would also be very complex in terms of the equipment required. It is more effective to raise the pressure in the presaturator. In this way, with less than full saturation, the same amount of hydrogen can be dissolved as would require complete saturation at lower pressure.

Thereafter, the fuel enriched with hydrogen is brought in contact with a suitable adsorber. Depending on the adsorption mechanism of the adsorbent used, either the sulfur that has been liberated from the organic sulfur compounds, or the entire sulfur compound, is deposited in the adsorber. The gas content during the entire process is below saturation so that no gas phase, distinct from the liquid phase, is present in the adsorber. The process flow leaving the adsorber then comprises the largely desulfurized fuel and small amounts of hydrogen solute.

In principle, the adsorption step can take place at conventional temperatures, such as at 200 to 400° C., analogous to the S Zorb process, depending on the adsorbent selected and the reaction kinetics of the adsorption step. However, it is particularly advantageous with the method according to the invention that the adsorption step can also take place at preferably moderate temperatures, which is to say at room temperature or slightly elevated temperatures of up to 200° C. While it was found that in principle the adsorption kinetics are less advantageous at low temperatures, this disadvantage can be more than compensated for by the considerable energy savings.

As is customary for other adsorption methods, the regeneration of the adsorption agent can optionally be carried out discontinuously when used in a fixed bed adsorber, or continuously when using a fluidized bed adsorber. The time at which an adsorbent must be regenerated depends on several factors, for example the execution of the process or the specified limits for desulfurization, and can be easily determined by a person skilled in the art.

Desulfurization using the method according to the invention is not limited to high sulfur contents, but is also possible, for example, for low sulfur contents of 10 ppm, for example, for post-desulfurization downstream of the hydrofiner from 20 ppm to 1 ppm. The adsorption step described is particularly advantageous in low desulfurization.

The device that is suited to carrying out the method according to the invention thus comprises not only the actual temperature-controllable reaction having the suitable adsorbent, but also a presaturator upstream thereof, in which the liquid fuel can be enriched with a hydrogen-containing gas.

Depending on the execution of the method, either a plurality of reactors are available, which can be run successively, wherein the reactors that are not used are provided for regenerating the adsorbent, or a fluidized bed reactor is employed, from which adsorbent is withdrawn continuously, regenerated and returned.

The subject matter of the invention will be described hereinafter in more detail based on one FIGURE, without thereby limiting the subject matter of the invention.

### BRIEF DESCRIPTION OF THE DRAWING

FIG. 1 is a schematic view of the method according to one embodiment of the invention of adsorptive desulfurization with presaturation.

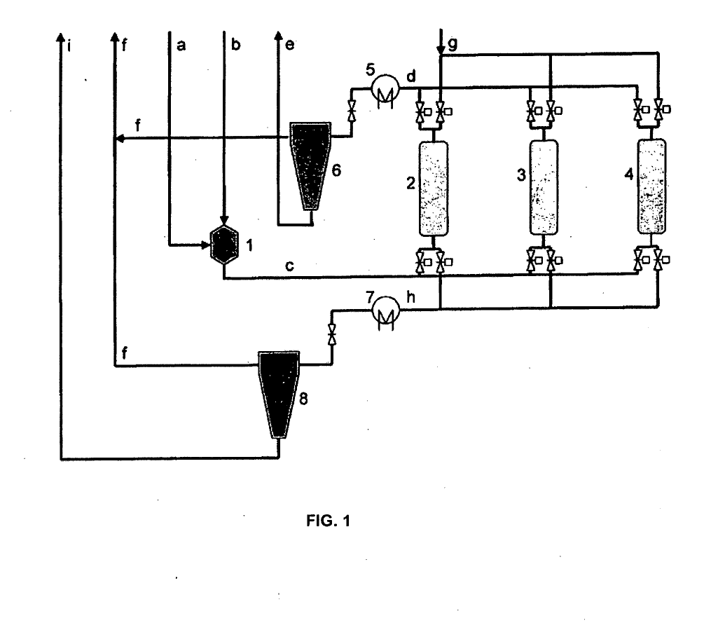

In the FIGURE, the following meanings apply:

1 Presaturator

2, 3, 4 Adsorber reactors

5, 7 Heat exchanger

6, 8 Gas/liquid separating unit

and

a Fuel

b Hydrogen or hydrogen-containing gas mixture

c Fuel containing hydrogen

d Product flow, comprising desulfurized fuel and sulfur-containing exhaust gas

e Desulfurized fuel

f Exhaust gas, comprising sulfur as hydrogen sulfide or sulfur dioxide

g Regeneration gas for adsorbent

h Regeneration gas charged with sulfur

i Fuel residue

### DESCRIPTION OF THE PREFERRED EMBODIMENTS

For the desulfurization of kerosene, the fuel (a) is first delivered into the presaturator (1). In addition, hydrogen-rich gas (b) is supplied to the container. In the presaturator (1), the amount of hydrogen-rich gas required for the adsorption step is dissolved in the liquid fuel. The liquid fuel enriched with hydrogen-rich gas (c) is then conducted through a fixed bed reactor (2) with an adsorbent suited for desulfurization.

In the adsorber reactor, either the sulfur liberated from the organic sulfur compounds, or the entire sulfur compound, is deposited on the surface of the adsorbent so that the sulfur content in the fuel is considerably reduced at the outlet of the reactor. The largely desulfurized fuel (d) is cooled (5) and depressurized, whereby the remaining hydrogen-containing gas dissolved in the fuel exits. In a fuel cell system, this gas, together with the fuel, would be conducted into the reformer, for example, which is not problematic because this is a minimal amount. In the refinery, the gas can be separated again and either be burned or used further.

If the sulfur content at the outlet of the reactor (2) rises above a specified value, the fuel is conducted across a further fixed bed reactor (3, 4). The adsorbent of the reactor (2) is regenerated by a gaseous medium (g). In addition, depending on the adsorbent, an activation step using a changed gas composition may be required prior to renewed adsorption. During the regeneration of the reactor (2), the reactors (3) and (4) are used consecutively for adsorption. In this way, a continuous product flow can be ensured. The number of reactors present at the same time depends on the ratio of the adsorption period to the regeneration period. In the present example, the regeneration period takes twice as long as the adsorption phase. For this reason, a total of three reactors are required. The gas flow to the regeneration step (g) is likewise cooled (7) after exiting the reactor to be regenerated and is depressurized. Thereafter, the fuel residues (i) removed from the system as residue are separated (8) from the gas flow. The separated gas flow (f) is fed to the exhaust air together with the gas flow (f) separated downstream of the adsorber.

1. A method for reducing the organic sulfur content in a sulfur-containing liquid fuel, comprising the following steps:
a) bringing the sulfur-containing liquid fuel in contact with a hydrogen-rich gas so that the fuel is enriched with the hydrogen-rich gas; and
b) bringing the liquid fuel enriched with hydrogen in contact with an adsorbent in a reactor, wherein at least part of the sulfur or organic sulfur compounds in the fuel are adsorbed at the surface of the adsorber.

2. The method according to claim 1, wherein the liquid fuel comprises saturated hydrocarbons, cyclic hydrocarbons, aromatic hydrocarbons and/or unsaturated hydrocarbons.

3. The method according to claim 1, wherein a middle distillate or gasoline having a boiling temperature between 150 and 450° C. is used as the liquid fuel.

4. The method according to claim 3, wherein diesel, gasoline, kerosene or jet fuel is used as the liquid fuel.

5. The method according to claim 3, wherein the liquid fuel used comprises thiophenes, benzothiophenes or dibenzothiophenes as the sulfur components.

6. A method according to claim 1, wherein the liquid fuel has a total sulfur content of up to 50,000 ppm S, expressed as elemental sulfur.

7. A method according to claim 1, wherein in step b), hydrogen-saturated liquid fuel in the reactor is brought in contact with the adsorbent.

8. A method according to claim 1, wherein the adsorbent used is regenerated discontinuously.

9. A method according to claim 1, wherein the content of organic sulfur compounds in the liquid fuel at an outlet of a reactor is reduced to less than 3000 ppm.

10. A method according to claim 1, wherein the contact of the hydrogen-enriched fuel with the adsorbent takes place at temperatures between 20° C. and 450° C., and at pressures between 1 and 50 bar.

11. A method according to claim 1, wherein in a downstream treatment step the excess unconverted hydrogen-rich gas solute is removed again from the fuel depleted from organic sulfur compounds.

12. A device for carrying out the method according to claim 1, comprising a presaturator having an inflow and outflow line for a liquid fuel, an inflow and outflow line for a hydrogen-containing gas, and a reactor connected to the presaturator by a fuel line, comprising an adsorbent, which is able to adsorb part of the sulfur or organic sulfur compounds from the fuel at the surface of the adsorber.

13. The device according to claim 12, comprising means for heating the reactor to temperatures between 20 and 400° C.

14. A device according to claim 1, comprising a fluidized bed or fixed bed reactor.

15. A method according to claim 1, wherein the liquid fuel has a total sulfur content of between 10 and 20,000 ppm S, expressed as elemental sulfur.

16. A method according to claim 1, wherein the adsorbent used is regenerated continuously.

17. A method according to claim 1, wherein the content of organic sulfur compounds in the liquid fuel at an outlet of a reactor is reduced to less than 1000 ppm.

18. A method according to claim 1, wherein the content of organic sulfur compounds in the liquid fuel at an outlet of a reactor is reduced to less than 10 ppm.

19. A method according to claim 1, wherein the contact of the hydrogen-enriched fuel with the adsorbent takes place at temperatures between 20° C. and 450° C. and at pressures between 3 and 20 bar.

20. A method according to claim 1, wherein the contact of the hydrogen-enriched fuel with the adsorbent takes place at temperatures between 80° C. and 180° C., and at pressures between 1 and 50 bar.

21. A method according to claim 1, wherein the contact of the hydrogen-enriched fuel with the adsorbent takes place at temperatures between 80° C. and 180° C., and at pressures between 3 and 20 bar.
